(19) United States
(12) Patent Application Publication
(10) Pub. No.: US 2024/0308929 A1
(43) Pub. Date: Sep. 19, 2024

(54) COMPOSITIONS FOR DELIVERY OF AN ELEMENT TO A PLANT AND METHODS OF MAKING SAME

(71) Applicant: LUCENT BIOSCIENCES, INC., West Vancouver (CA)

(72) Inventors: Farahnaz NOURMOHAMMADIAN, West Vancouver (CA); Peter GROSS, Lions Bay (CA)

(21) Appl. No.: 18/577,023

(22) PCT Filed: Jul. 8, 2022
(86) PCT No.: PCT/CA2022/000036

§ 371 Date: Jan. 5, 2024

Related U.S. Application Data
(60) Provisional application No. 63/220,115, filed on Jul. 9, 2021.

(51) Int. Cl. C05D 9/02; C05G 5/00; C08L 97/02

(52) U.S. Cl. CPC C05D 9/02; C05G 5/45; C08L 97/02

(57) ABSTRACT

The invention provides compositions comprising a polymeric carrier of cellulose and/or starch, and an element. The carrier is insoluble in water and a salt of the element is soluble or partially soluble in water. The compositions include at least about 5% (wt/wt) of the element, based on a total weight of the composition, and have particle sizes between about 0.05 mm and about 1.5 mm. Also provided are methods of making such compositions and methods for using the compositions to deliver the element to a plant.

### FIELD

This invention relates to compositions and methods for delivery of an element to plants, and methods of preparing such compositions. In particular, the invention relates to compositions including a polymeric carrier comprising cellulose and/or starch, wherein the carrier is insoluble in water, and an element, wherein a salt of the element is soluble or partially soluble in water. Also provided are solid state and microwave-assisted methods for preparing such compositions.

### BACKGROUND

In modern agriculture, nutrients are applied to soils to maximize the growth of plants. However, a significant proportion of nutrients simply wash away from the soils because they are water soluble. For example, rain and irrigation may cause applied nutrients to move vertically through the soil and away from plant roots, thereby limiting or prohibiting nutrient uptake by plants. Another issue with nutrient solubility in soils is agricultural run-off, which is a major contributor to the eutrophication of fresh water bodies. Phosphate, a common fertilizer, may promote the growth of cyanobacteria and algae in water bodies, which in turn can produce harmful toxins and cause a depletion of oxygen.

Trace metals, such as iron, zinc, copper, boron and magnesium, are also important components of soil chemistry that may be depleted by environmental effects and crop uptake, resulting in decreased crop yields. Trace mineral depletion may be caused by NPK fertilizers, which are known to dilute the concentrations of other nutrients in plants. Although NPK fertilizers improve crop yields, their use combined with progressively higher-yielding crop varieties may produce foods with lower mineral and nutrient concentrations than their less productive ancestors (Henkel M. Sustainable Agriculture III: Agricultural Practices. 2005; 18-19).

Trace metal deficiency in soil may be mitigated by replacing trace metals in soil; however, trace metal leaching limits the efficacy of fertilizers that contain these nutrients. Furthermore, over application of trace metals may result in reduced crop growth or crop mortality (Kampfenkel K, Van Montagu M, Inze D. Effects of Iron Excess on Nicotiana plumbaginifolia Plants (Implications to Oxidative Stress). Plant Physiology. 1995; 107(3):725-735). As a result, application of trace metals to soils must be done carefully and must avoid local areas of high concentration.

Trace metals should also be present in bioavailable form. Mostly, free trace metals in cationic form interact with the soil's organic chelates quite tightly, in a way that the plant and soil microbiome cannot consume these metals. In this case, trace metals are not bioavailable to the plant and soil microbiome.

U.S. Pat. No. 8,642,507 discloses a fertilizer formulation for the reduction of nutrient and pesticide leaching. Semi-soluble decomposable polymers are used which release nutrients continuously in the presence of water. However, these formulations release the nutrients regardless of biological demand.

Thus, there remains a need for a material that retains nutrients or elements, does not leach elements into its surroundings until sequestered though biological demand, and does not manifest toxicity to plants even if applied in high local concentrations.

### SUMMARY

In one aspect, the present disclosure provides compositions comprising a polymeric carrier and an element. Also provided are solid state and microwave-assisted methods of making such compositions.

Various aspects of the present disclosure provide a composition comprising a polymeric carrier comprising cellulose and/or starch, wherein the polymeric carrier is insoluble in water; and an element, wherein a salt of the element is soluble or partially soluble in water, wherein the composition comprises at least about 5% (wt/wt) of the element, based on a total weight of the composition, and wherein the composition has particle sizes between about 0.05 mm and about 1.5 mm.

In various embodiments, the composition is insoluble in water.

In various embodiments, the element is a micronutrient for plant growth. In various embodiments, the element may be Fe, Mn, Zn, Cu, Ca or Mo. For example, the element may be Fe²⁺, Fe³⁺, Mn²⁺, Ca²⁺, Cut, Cu²⁺, Mo⁴⁺, Mo⁶⁺ or Zn²⁺. For example, the element may be Fe²⁺, Fe³⁺, Mn²⁺ or Zn²⁺.

In various embodiments, the composition comprises at least about 6% (wt/wt) of the element, based on the total weight of the composition. In various embodiments, the composition comprises at least about 8% (wt/wt) of the element, based on the total weight of the composition. In various embodiments, the composition comprises at least about 10% (wt/wt) of the element, based on the total weight of the composition. In various embodiments, the composition comprises at least about 12% (wt/wt) of the element, based on the total weight of the composition. For example, the composition may comprise at least about 15% (wt/wt) of the element, based on the total weight of the composition. In a further example, the composition comprises at least about 20% (wt/wt) of the element, based on the total weight of the composition.

In various embodiments, the polymeric carrier comprises about 0.2% to about 40% (w/w) lignin and about 60% to about 98.8% (w/w) cellulose to total weight of the carrier. For example, the polymeric carrier may comprise about 5% to about 30% (w/w) lignin and about 70% to about 95% (w/w) cellulose to total weight of the carrier. For example, the polymeric carrier may comprise about 15% to about 20% (w/w) lignin and about 80% to about 85% (wt/wt) cellulose to total weight of the carrier. For example, the polymeric carrier may comprise about 40% (wt/wt) lignin and about 60% (wt/wt) cellulose to total weight of the carrier.

In various embodiments, the particle sizes of the composition are between about 0.10 mm and about 1 mm. In various embodiments, the particle sizes of the composition are between about 0.1 mm to 1.5 mm. For example, the particle sizes of the composition may be between about 0.1 mm and about 1 mm.

In various embodiments, the polymeric carrier is lentil fibre, pea fibre, rice hulls, wheat husk, starch (for example, lentil fibre starch), coconut husk, cattle manure, cannabis fibre, wood fibre, wheat straw, barley straw, oat fibre or a combination thereof.

In various embodiments, the composition comprises between about 1% (wt/wt) and about 13% (wt/wt) water, based on the total weight of the composition. In various embodiments, the composition comprises between about 1% (wt/wt) and about 10% (wt/wt) water, based on the total weight of the composition. For example, the composition may comprise about 1% (wt/wt) water, about 2% (wt/wt) water, about 3% (wt/wt) water, about 4% (wt/wt) water, about 5% (wt/wt) water, about 6% (wt/wt) water, about 7% (wt/wt) water, about 8% (wt/wt) water, about 9% (wt/wt) water, about 10% (wt/wt) water, about 11% (wt/wt) water, or about 12% (wt/wt) water, or any amount therebetween, based on the total weight of the composition.

Various aspects of the present disclosure also provide a method for delivering an element to an organism, the method comprising adding a composition as disclosed herein to an environment of the organism. In various embodiments, the environment is soil and the organism is a plant.

Various aspects of the present disclosure also provide a solid state method for preparing a composition as disclosed herein, the method comprising: combining a base and a polymeric carrier comprising cellulose and/or starch in the absence of water or a solvent, or in the presence of water or a solvent; adding a salt of an element and/or an oxide of an element, with water to form a mixture; heating and mixing the mixture to form the composition; separating the composition from the mixture; and drying the composition to a moisture content of about 13% (wt/wt) or less. For example, the moisture content may be about 12% (wt/wt) or less. For example, the moisture content may be about 10% (wt/wt) or less. For example, the moisture content may be about 8% (wt/wt) or less. For example, the moisture content may be about 6% (wt/wt) or less. For example, the moisture content may be about 4% (wt/wt) or less. For example, the moisture content may be about 2% (wt/wt) or less.

In various embodiments, the heating step is conducted at a temperature between about 55° C. and about 80° C.

In various embodiments, the base is anhydrous sodium carbonate, a sodium carbonate hydrate, potassium carbonate, anhydrous sodium hydroxide, a sodium hydroxide hydrate, anhydrous potassium hydroxide or a potassium hydroxide hydrate. Alternatively, the base may be sodium bicarbonate.

In various embodiments, the salt and/or the oxide is a salt and/or an oxide of Zn, Fe, Mn, Cu, Ca and/or Mo. In various embodiments, the salt is ZnSO₄, FeSO₄, MnSO₄, ZnCl₂, FeCl₃, MnCl₂, CuCl₂, CuSO₄, CaCl₂), CaSO₄, MoCl₂, MoCl₃ or Mo(SO₄)₃. In various embodiments, the oxide is zinc oxide, iron (II) oxide, iron (II,III) oxide, iron (III) oxide, manganese (II) oxide, manganese (II,III) oxide, manganese (III) oxide, manganese dioxide, manganese (VI) oxide, manganese (VII) oxide, copper (I) oxide, copper (II) oxide, copper peroxide, copper (III) oxide, copper (IV) oxide, calcium oxide, molybdenum (IV) oxide or molybdenum (VI) oxide.

In various embodiments, the carrier is lentil fibre, pea fibre, rice hulls, wheat husk, starch (for example, lentil fibre starch), coconut husk, cattle manure, cannabis fibre, wood fibre, wheat straw, barley straw, oat fibre or a combination thereof.

In various embodiments, up to about 30% (w/w) base to total weight of the carrier is combined with the base.

In various embodiments, the drying step comprises drying the composition to a moisture content of about 1% (wt/wt) to about 13% (wt/wt) based on a total weight of the composition.

In various embodiments, the method further comprises rinsing the composition prior to the separating step. For example, the rinsing step may be conducted with water.

Various aspects of the present disclosure also provide a microwave assisted method for preparing a composition as disclosed herein, the method comprising: combining a base and a polymeric carrier comprising cellulose or a combination of cellulose and starch, in the absence of water or a solvent or in the presence of water or a solvent; adding a salt or an oxide of an element with water to form a mixture; irradiating the mixture with microwave energy at atmospheric pressure or less to a temperature of about 40° C. to about 90° C.; separating the composition from the mixture; and drying the composition to a moisture content of about 13% (wt/wt) or less. For example, the moisture content may be about 12% (wt/wt) or less. For example, the moisture content may be about 10% (wt/wt) or less. For example, the moisture content may be about 8% (wt/wt) or less. For example, the moisture content may be about 6% (wt/wt) or less. For example, the moisture content may be about 4% (wt/wt) or less. For example, the moisture content may be about 2% (wt/wt) or less.

In various embodiments, the base is anhydrous sodium carbonate, a sodium carbonate hydrate, potassium carbonate, anhydrous sodium hydroxide, a sodium hydroxide hydrate, anhydrous potassium hydroxide or a potassium hydroxide hydrate. Alternatively, the base may be sodium bicarbonate.

In various embodiments, the salt and/or the oxide is a salt and/or oxide of Zn, Fe, Mn, Cu, Ca and/or Mo. In various embodiments, the salt is ZnSO₄, FeSO₄, MnSO₄, ZnCl₂, FeCl₃, MnCl₂, CuCl₂, CuSO₄, CaCl₂), CaSO₄, MoCl₂, MoCl₃ or Mo(SO₄)₃, In various embodiments, the oxide is zinc oxide, iron (II) oxide, iron (II,III) oxide, iron (III) oxide, manganese (II) oxide, manganese (II,III) oxide, manganese (III) oxide, manganese dioxide, manganese (VI) oxide, manganese (VII) oxide, copper (I) oxide, copper (II) oxide, copper peroxide, copper (III) oxide, copper (IV) oxide, calcium oxide, molybdenum (IV) oxide or molybdenum (VI) oxide.

In various embodiments, the carrier is lentil fibre, pea fibre, rice hulls, wheat husk, coconut husk, cattle manure, cannabis fibre, wood fibre, wheat straw, barley straw, oat fibre or a combination thereof.

In various embodiments, up to about 30% (w/w) base to total weight of the carrier is combined with the base.

In various embodiments, the drying step comprises drying the composition to a moisture content of about 1% (wt/wt) to about 13% (wt/wt) based on a total weight of the composition.

In various embodiments, the method further comprises rinsing the composition prior to the separating step. For example, the rinsing step may be conducted with water.

In various embodiments, the mixture is irradiated with microwave energy at atmospheric pressure or less to a temperature of about 50° C. to about 70° C.

Other aspects and features of the present invention will become apparent to those of ordinary skill in the art upon review of the following description of specific embodiments of the invention in conjunction with the accompanying claims.

### BRIEF DESCRIPTION OF THE DRAWINGS

In drawings which illustrate embodiments of the disclosure,

FIGS. 1(a) and 1(b) show evolution of microbial biomass carbon (“MBC”) with addition of different sources of zinc, including a composition according to an embodiment of the disclosure (labeled “RiceH”), zinc chloride and zinc sulphate in two different soil samples labeled (a) Farm #2 and (b) Field #24 during 60-day incubation periods.

FIGS. 2(a) and 2(b) show evolution of microbial biomass nitrogen (“MBN”) with addition of different sources of zinc, including a composition according to an embodiment of the disclosure (labeled “RiceH”), zinc chloride and zinc sulphate in two different soil samples labeled (a) Farm #2 and (b) Field #24 during 60-day incubation periods.

FIGS. 3(a) and 3(b) show evolution of Mehlich-3 extractable zinc with addition of different sources of zinc, including a composition according to an embodiment of the disclosure (labeled “RiceH”), zinc chloride and zinc sulphate in two different soil samples labeled (a) Farm #2 and (b) Field #24 during 60-day incubation periods.

FIGS. 4(a), 4(b), 4(c) and 4(d) show adsorption curves of zinc with two sources including a composition according to an embodiment of the disclosure (labeled “Rice Husk”) and zinc chloride in two different soil samples labeled Farm #2 ((a) and (b)) and Field #24 ((c) and (d)).

FIGS. 5(a), 5(b), 5(c) and 5(d) show desorption curves of zinc with two sources including a composition according to an embodiment of the disclosure (labeled “Rice Husk”) and zinc chloride in two different soil samples labeled Farm #2 ((a) and (b)) and Field #24 ((c) and (d)).

FIGS. 6(a) and 6(b) show cabbage fresh weight (g/pot) in response to zinc application rates applied using a composition according to an embodiment of the disclosure (labeled “Rice Husk”), zinc chloride and zinc sulphate under (a) heavy textured (labeled Farm #2) and (b) light textured (labeled “Field #24”) soils in a pot experiment.

FIGS. 7(a) and 7(b) show cabbage dry weight (g/pot) in response to zinc application rates applied using a composition according to an embodiment of the disclosure (labeled “Rice Husk”), zinc chloride and zinc sulphate under (a) heavy textured (labeled Farm #2) and (b) light textured (labeled “Field #24”) soils in a pot experiment.

FIGS. 8(a) and 8(b) show cabbage zinc uptake (g/pot) in response to zinc application rates applied using a composition according to an embodiment of the disclosure (labeled “Rice Husk”), zinc chloride and zinc sulphate under (a) heavy textured (labeled Farm #2) and (b) light textured (labeled “Field #24”) soils in a pot experiment.

### DETAILED DESCRIPTION

In the context of the present disclosure, various terms are used in accordance with what is understood to be the ordinary meaning of those terms.

In various embodiments, the disclosure provides compositions for providing nutrients to plants. The compositions comprise a polymeric carrier comprising cellulose and/or starch, wherein the carrier is insoluble water; and an element, wherein a salt of the element is soluble or partially soluble in water, wherein the composition comprises at least about 5% (wt/wt) of the element, based on a total weight of the composition, and wherein the composition has particle sizes between about 0.05 mm and about 1.5 mm. By having a composition comprising at least about 5% (wt/wt) of the element and particle sizes between about 0.05 mm and 1.5 mm, the composition can deliver more nutrients to plants due to higher nutrient loading and increased surface area of the particles, as compared to compositions with lower content of element and larger particles. Furthermore, the smaller particles have broader application for use in agriculture as they can be used in seed coating and pelletizing, as a fertilizer additive or fertilizer coating, and as an additive to soil mixtures, such as potting soil or other growth media.

The term “element” refers to a micronutrient that sustains an organism in its existence, by promoting organism growth, replacing loss and/or providing energy. The element can be taken into the organism by any means that the organism uses to take in nutrients. For example, if the organism is a plant, it typically absorbs nutrients through its roots and leaves. The element may be a micronutrient for plant growth. In various embodiments, the element may be Mn, Fe, Co, Cu, Zn, B, Si, Ca, Mo or Mg or any isotope thereof. In various embodiments, the element is Fe²⁺, Fe³⁺, Mn²⁺, Ca²⁺, Cut, Cu²⁺, Mo⁴⁺, Most or Zn²⁺. In various embodiments, the element is Zn²⁺, Mn²⁺, Fe²⁺ or Fe³⁺. The composition comprises at least about 5% (wt/wt) of the element, based on a total weight of the composition. For example, the composition may comprise at least about 8% (wt/wt) of the element, based on the total weight of the composition. For example, the composition may comprise at least about 10% (wt/wt) of the element, based on the total weight of the composition. For example, the composition may comprise at least about 12% (wt/wt) of the element, based on the total weight of the composition. For example, the composition may comprise at least about 15% (wt/wt) of the element, based on the total weight of the composition. For example, the composition may comprise at least about 18% (wt/wt) of the element, based on the total weight of the composition. For example, the composition may comprise at least about 20% (wt/wt) of the element, based on the total weight of the composition. For example, the composition may comprise between about 10% (wt/wt) and about 20% (wt/wt) of the element, based on the total weight of the composition.

A salt of the element is soluble or partially soluble in water. The term “partially soluble” may mean that 1 gram of elemental salt requires 100 mL to 1000 mL of water to dissolve.

In various embodiments, the element is in a biologically available form. The term “biologically available form” means that a micronutrient is present in an oxidation state that allows for transport across a cellular membrane without requiring a reduction or change in oxidation state prior to cross-membrane transport.

The term “labile” refers to an association between the polymeric carrier and an element that is apt or likely to break, or rapidly cleave.

The term “non-labile” refers to an association between the polymeric carrier and the element that is substantially stable. For example, the association between the polymeric carrier and element may be non-labile in water or other liquids or solvents. In various embodiments, the association is non-labile in water of varying ionic strength and over a wide range of pH. In various embodiments, the association between the polymeric carrier and the element is non-labile in the presence of water at a pH between about 4 and about 10, or any pH therebetween. In various embodiments, the association is non-labile in the presence of water at a pH between about 5 and about 10. In various embodiments, the association is non-labile in the presence of water at a pH between about 6 and about 10. In various embodiments, the association is non-labile in the presence of water at a pH between about 7 and about 10. In various embodiments, the association is non-labile in the presence of water at a pH between about 7 and about 9. In various embodiments, the association is non-labile in the presence of water at a pH between about 7.5 and about 10. In various embodiments, the association is non-labile in the presence of water at a pH between about 7.5 and about 9.

The term “biological demand” refers to an act of acquisition or interaction between an organism and the composition in which the element is acquired or sequestered from the composition and taken into cells through trans-membrane transport or into tissues of the organism.

A rate of release of the element from the polymeric carrier is governed by the level of biological demand around the composition. For example, a higher concentration of biological demand may result in a faster release of the element from the polymeric carrier than a lower concentration of biological demand. The higher concentration of biological demand may result from the number of microorganisms in a particular area. As the rate of release depends on biological demand, an area of high localized concentration of element does not form. Such an area of high localized concentration is undesirable as the element may be toxic to plants in high concentrations. Details of the mechanism of the release of the element from the composition and uptake by a plant is described in more detail below.

In various embodiments, the polymeric carrier comprises cellulose and/or starch. The polymeric carrier may comprise lignin, cellulose or a combination thereof. For example, the carrier may comprise about 0.2% to about 40% (w/w) lignin and about 60% to about 98.8% (w/w) cellulose to total weight of the carrier, or any amounts therebetween. In various embodiments, the polymeric carrier consists of cellulose. In various embodiments, the polymeric carrier consists of starch. In various embodiments, the polymeric carrier is a combination of cellulose and starch. In various embodiments, the polymeric carrier is lentil fibre, pea fibre, oat fibre, rice hulls, rice husk, wheat husk, starch (for example, lentil fibre starch), coconut husk, coconut fibre, cattle manure, cannabis fibre, wood fibre, wood pulp, wheat straw, barley straw, cotton, flax, jute, hemp, bamboo or any combination thereof. In various embodiments, the polymeric carrier is lentil fibre. The term “fibre” refers to a component of plant material that is not soluble in water. The polymeric carrier may also be synthetically produced.

Lignin is a naturally occurring amorphous complex cross-linked organic macromolecule that comprises an integral component of all plant biomass. The chemical structure of lignin is irregular in the sense that different structural units (e.g. phenylpropane units) are not linked to each other in any systematic order. It is known that lignin comprises pluralities of two monolignol monomers that are methoxylated to various degrees (trans-coniferyl alcohol and trans-sinapyl alcohol) and a third non-methoxylated monolignol (trans-p-coumaryl alcohol). Various combinations of these monolignols comprise three building blocks of phenylpropanoid structures (guaiacyl monolignol, syringyl monolignol and p-hydroxyphenyl monolignol) that are polymerized via specific linkages to form a lignin macromolecule comprising both aliphatic hydroxyl groups and phenolic hydroxyl groups.

Cellulose is a polysaccharide consisting of a linear chain of β(1→4) linked D-glucose units having the formula (C₆H₁₀O₅)ₙ and comprising aliphatic hydroxyl groups and phenolic hydroxyl groups.

Starch is a polymeric carbohydrate consisting of numerous glucose units joined by glycosidic bonds. It consists of two types of molecules, the linear and helical amylose, and the branched amylopectin.

The particle sizes of the composition are between about 0.05 mm and about 1.5 mm, or any range therebetween. For example, the particle sizes of the composition may be between about 0.05 mm and about 0.2 mm. For example, the particle sizes of the composition may be between about 0.05 mm and about 1 mm. For example, the particle sizes of the composition may be between about 0.1 mm and about 1 mm.

The compositions disclosed herein are prepared by a solid state method or a microwave assisted method. Use of these methods result in reduced wastewater streams as opposed to solution-based synthesis methods. This decreases the cost of the methods and minimizes environmental impacts. Furthermore, these methods result in increased yield and purity of the compositions, as compared to solution-based synthesis methods. Use of the solid state and microwave assisted methods also results in compositions with smaller particle sizes. For solution-based methods, the smaller sized particles are lost in the various washing and filtering steps. The microwave assisted methods also have a significantly decreased reaction time, thereby decreasing the costs of production of the composition.

For the solid state method, a base and the polymeric carrier are combined in the absence of water or a solvent, or in the presence of water or a solvent. The base is used to deprotonate the hydroxyl groups of the polymeric carrier. In various embodiments, the base is sodium bicarbonate. In various embodiments, the base is anhydrous sodium carbonate, a sodium carbonate hydrate, potassium carbonate, anhydrous sodium hydroxide, a sodium hydroxide hydrate, anhydrous potassium hydroxide or a potassium hydroxide hydrate. Up to about 30% (wt/wt) base to total weight of the carrier may be combined with the carrier. For example, about 5%, about 10%, about 20% or about 30% (w/w) base to total weight of the carrier may be used.

A salt or an oxide of the element, in water or a solvent, or in the absence of water or a solvent, is then added to form a mixture. The salt or oxide may be a salt or an oxide of Mn, Fe, Co, Cu, Zn, B, Si, Mg, Ca or Mo. The salt may be, for example, ZnSO₄, FeSO₄, MnSO₄, ZnCl₂, FeCl₃, MnCl₂, CuCl₂, CuSO₄, CaCl₂), CaSO₄, MoCl₂, MoCl₃ or Mo(SO₄)₃. The salt may be, for example, ZnSO₄, FeSO₄, MnSO₄, ZnCl₂, FeCl₃ or MnCl₂. The oxide may be, for example, zinc oxide, iron (II) oxide, iron (II,III) oxide, iron (III) oxide, manganese (II) oxide, manganese (II,III) oxide, manganese (III) oxide, manganese dioxide, manganese (VI) oxide, manganese (VII) oxide, copper (I) oxide, copper (II) oxide, copper peroxide, copper (III) oxide, copper (IV) oxide, calcium oxide, molybdenum (IV) oxide or molybdenum (VI) oxide.

To form the composition, the mixture is heated to a temperature of between about 50° C. and 80° C., such as, for example, 60° C., mixed, cooled back to room temperature. In various embodiments, the composition may also be rinsed. The rinsing step may be completed using water. The composition is then separated from the mixture, and dried to a moisture content of about 13% (wt/wt) or less. For example, the composition may be dried to a moisture content of 10% (wt/wt) or less. For example, the composition may be dried to a moisture content of about 5% (wt/wt) or less. For example, the composition may be dried to a moisture content of about 1% (wt/wt).

For the microwave assisted method, a base and the polymeric carrier are combined in the absence of water or a solvent, or in the presence of water or a solvent. The polymeric carrier comprises cellulose or a combination of cellulose and starch. The base is used to deprotonate the hydroxyl groups of the polymeric carrier. In various embodiments, the base is sodium bicarbonate. In various embodiments, the base is anhydrous sodium carbonate, a sodium carbonate hydrate, potassium carbonate, anhydrous sodium hydroxide, a sodium hydroxide hydrate, anhydrous potassium hydroxide or a potassium hydroxide hydrate. Up to about 30% (wt/wt) base to total weight of the carrier may be combined with the carrier. For example, about 5%, about 10%, about 20% or about 30% (w/w) base to total weight of the carrier may be used.

A salt or an oxide of the element, in water, is then added to form a mixture. The salt or oxide may be a salt or oxide of Mn, Fe, Co, Cu, Zn, B, Si, Mg, Ca or Mo. The salt may be, for example, ZnSO₄, FeSO₄, MnSO₄, ZnCl₂, FeCl₃, MnCl₂, CuCl₂, CuSO₄, CaCl₂), CaSO₄, MoCl₂, MoCl₃ or Mo(SO₄)₃. The salt may be, for example, ZnSO₄, FeSO₄, MnSO₄, ZnCl₂, FeCl₃ or MnCl₂. The oxide may be, for example, zinc oxide, iron (II) oxide, iron (II,III) oxide, iron (III) oxide, manganese (II) oxide, manganese (II,III) oxide, manganese (III) oxide, manganese dioxide, manganese (VI) oxide, manganese (VII) oxide, copper (I) oxide, copper (II) oxide, copper peroxide, copper (III) oxide, copper (IV) oxide, calcium oxide, molybdenum (IV) oxide or molybdenum (VI) oxide.

To form the composition, the mixture is irradiated with microwave energy at atmospheric pressure or less to a temperature of between about 50° C. and 80° C., such as, for example, 60° C., and cooled to room temperature. In various embodiments, the composition is also rinsed. The rinsing step may be completed using water. In various embodiments, the mixture is irradiated at atmospheric pressure. In various embodiments, the mixture is irradiated under vacuum. The composition is then separated from the mixture, and dried to a moisture content of about 13% (wt/wt) or less. For example, the composition may be dried to a moisture content of about 10% (wt/wt) or less. For example, the composition may be dried to a moisture content of about 5% (wt/wt) or less. For example, the composition may be dried to a moisture content of about 1% (wt/wt). As compared to a solution-based method which requires a reaction time of about 5 hours, the reaction time for the irradiation step of the microwave assisted method is about 30 seconds to 300 seconds, such as about 60 seconds, thereby significantly increasing the efficiency of the method and decreasing costs.

In various embodiments, the association between the polymeric carrier and the element comprises chemical bonding. In various embodiments, the chemical bonding comprises element-hydroxide covalent bonding. In various embodiments, the association comprises adsorption, element-hydroxide covalent bonding, ionic interaction, Van der Waals interactions, or any combination thereof. In various embodiments, the association comprises element-hydroxide covalent bonding. In various embodiments, the element may form an aggregate of elements. In various embodiments, the aggregate comprises element-element covalent bonding.

In various embodiments, the composition is resistant to element leaching in water. In various embodiments, the carrier composition may minimize or decrease element leaching into water sources.

In various embodiments, addition of the composition to water, to soil, to an environment comprising water, or to an aqueous environment results in neutral change to surrounding pH. For example, when the composition is immersed in water, the pH of the water may remain substantially the same.

In various embodiments, the composition may be non-toxic. For example, the composition does not cause nutrient toxicity when deployed in high concentrations.

In various embodiments, the composition may be added to an environment of an organism in order to increase growth of the organism. The environment may be a slough, an estuary, an agricultural field or soil. The organism may be a plant. In various embodiments, the composition may be applied to soil.

### EXAMPLES

These examples illustrate various aspects of the invention, evidencing a variety of conditions for preparing compositions comprising a polymeric carrier comprising cellulose and/or starch, wherein the polymeric carrier is insoluble in water; and an element, wherein a salt of the element is soluble or partially soluble in water, wherein the composition comprises at least about 5% (wt/wt) of the element, based on a total weight of the composition, and wherein the composition has particle sizes between about 0.05 mm and about 1.5 mm. Selected examples are illustrative of advantages that may be obtained compared to alternative methods, and these advantages are accordingly illustrative of particular embodiments and not necessarily indicative of the characteristics of all aspects of the invention.

As used herein, the term “about” refers to an approximately +/−10% variation from a given value. It is to be understood that such a variation is always included in any given value provided herein, whether or not it is specifically referred to.

### Example 1: Preparation of a Composition Using Sodium Bicarbonate and Water

A polymeric carrier consisting of an organic fibre (wood pulp) (about 1 g) containing about 16% (w/w) lignin and about 84% (w/w) cellulose was mixed with distilled water (about 60 mL). The mixture was stirred at room temperature (about 21° C.) for a period of about 5 minutes. The mixture was then made alkaline using sodium bicarbonate at a percentage of about 30% (w/w) to total weight of the organic fibre. The pH of the mixture was about 11. The mixture was then allowed to rest for a period of about 5 to about 10 minutes. Next, Fe³⁺ salt was added to the mixture in the form of iron chloride at a ratio of about 20% (w/w) to the organic fibre. This mixture was then heated to a temperature of about 80° C. and maintained at about 80° C. for a period of about 1 hour. The mixture was cooled to room temperature for a period of about 5 hours. The carrier composition was isolated by filtering and washing with distilled water at room temperature and then allowing the composition to dry at room temperature. Alternatively, the composition was dried in a vacuum oven at about 40° C. to accelerate the final drying process.

Iron sulphate at a ratio of 20% (w/w) to the total weight of the carrier was substituted for iron chloride in the method described above. Metal chlorides and metal sulphates for Zn, Mn, Mg, B, Cu, Co, silicon monoxide and silicon tetraacetate may also be substituted for iron chloride. Iron sulphate may be substituted for iron chloride.

Nine different carriers were used in this Example. Each carrier was a variety of a wood pulp containing varying ratios of lignin and cellulose. All carriers were supplied by the Canfor Company. The carriers are listed in Table 1. The lignin content and cellulose content refer to % (w/w) to total weight of the carrier.

TABLE 1
Carriers used to prepare compositions
according to Examples 1 and 2

| | | Lignin | Cellulose |
|---|---|---|---|
| Carrier | Name | Content (%) | Content (%) |
| A | Aspen TMP | 8.2 | 91.8 |
| B | Softwood | 13.9 | 86.1 |
| C | WP 350 | 15.7 | 84.3 |
| D | Aspen Kraft | 0.2 | 99.8 |
| E | NBSK | 0.2 | 99.8 |
| F | EUCAL | 0.2 | 99.8 |
| G | BWP | 0 | 100 |
| H | UBWP | 1.2 | 98.8 |
| I | WP3254 | 27 | 73 |

### Example 2: Preparation of a Composition Using Triethylamine and Acetonitrile

A polymeric carrier consisting of an organic fibre (about 1 g) containing about 16% (w/w) lignin and about 84% (w/w) cellulose was mixed with acetonitrile (about 60 mL). The mixture was stirred at room temperature (about 21° C.) for a period of about 5 minutes. The mixture was then made alkaline using triethylamine at a percentage of about 30% (w/w) to the total weight of the carrier. The pH of the mixture was about 11. The mixture was then allowed to rest for a period of about 5 to about 10 minutes. Next, Fe³⁺ salt was added to the mixture in the form of iron chloride at a ratio of about 20% (w/w) to total weight of the carrier. This mixture was then heated to a temperature of about 80° C. and maintained at about 80° C. for a period of about 1 hour. The mixture was cooled to room temperature for a period of about 5 hours. The composition was isolated by filtering and washing with distilled water at room temperature and then drying at room temperature. Alternatively, the carrier composition was dried in a vacuum oven at about 40° C. to accelerate the final drying process.

As described above, various metal salts in varying amounts were also substituted for iron chloride. Furthermore, the method was repeated using the various wood pulps listed in Table 1.

### Example 3: Element Loading

The compositions produced according to Example 1 were tested for iron loading by elemental analysis. Analysis was undertaken with a CHN Analyzer. The CHN analysis provided the percent by weight of C, H, N and O in each sample. The difference between this percent by weight and the total weight of the sample was the amount of iron present, as there were no other elements present in the compositions. The results were confirmed by ICP-MS analysis. Table 2 shows the percentage weight of the loaded iron compared to the weight of wood pulp for various experimental conditions relating to carrier, reaction temperature, iron salt, and amount of base (% NaHCO₃ (w/w) to total weight of the carrier) used for the preparation of each composition using water as the solvent. The amount of iron in the compositions increased with increasing amounts of iron salt used for preparation of the compositions.

TABLE 2
Iron loading in compositions produced using
water as the solvent and NaHCO₃ as the base

| | Reaction | Iron | NaHCO₃ | Iron Loading |
|---|---|---|---|---|
| Carrier¹ | Temperature | salt | (% (w/w)) | (% (w/w)) |
| C | 80° C. | 20% (w/w) Fe₂(SO₄)₃ | 30 | 5 |
| C | 80° C. | 20% (w/w) FeCl₃ | 30 | 8 |
| C | 80° C. | 10% (w/w) FeCl₃ | 20 | 6 |
| C | 80° C. | 20% (w/w) FeCl₃ | 10 | 3 |
| C | 80° C. | 20% (w/w) FeCl₃ | 5 | 3 |
| C | 80° C. | 20% (w/w) FeCl₃ | 0 | 1 |
| C | 21° C. | 20% (w/w) FeCl₃ | 30 | 0.2 |
| D | 80° C. | 20% (w/w) FeCl₃ | 30 | 2 |
| I | 80° C. | 20% (w/w) FeCl₃ | 30 | 6.4 |

¹Carrier refers to the designation of the wood pulp from Table 1

The compositions produced according to Example 2 were tested for iron loading using the same elemental analysis approach described above. Table 3 shows the percentage weight of the loaded iron compared to the weight of wood pulp for various experimental conditions relating to carrier, reaction temperature, iron salt, and amount of base (%(C₂H₅)₃N (w/w) to total weight of the carrier) used for the preparation of each composition using acetonitrile as the solvent.

TABLE 3
Iron loading in compositions produced using acetonitrile
as the solvent and triethylamine as the base

| | Reaction | | Triethyl- | Iron |
|---|---|---|---|---|
| | Temper- | Iron | amine | Loading |
| Carrier¹ | ature | salt | (% (w/w)) | (% (w/w)) |
| A | 80° C. | 10% (w/w) Fe₂(SO₄)₃ | 30 | 6 |
| B | 80° C. | 10% (w/w) Fe₂(SO₄)₃ | 30 | 5 |
| C | 80° C. | 10% (w/w) Fe₂(SO₄)₃ | 30 | 4 |
| C | 80° C. | 20% (w/w) FeCl₃ | 30 | 5 |
| C | 80° C. | 10% (w/w) FeCl₃ | 30 | 5 |
| C | 80° C. | 5% (w/w) FeCl₃ | 30 | 3 |
| C | 21° C. | 10% (w/w) Fe₂(SO₄)₃ | 30 | 1 |
| D | 80° C. | 10% (w/w) Fe₂(SO₄)₃ | 30 | 5 |
| E | 80° C. | 10% (w/w) Fe₂(SO₄)₃ | 30 | 2 |
| F | 80° C. | 10% (w/w) Fe₂(SO₄)₃ | 30 | 4 |
| G | 80° C. | 10% (w/w) Fe₂(SO₄)₃ | 30 | 5 |
| H | 80° C. | 10% (w/w) Fe₂(SO₄)₃ | 30 | 4 |
| I | 80° C. | 10% (w/w) Fe₂(SO₄)₃ | 30 | 2 |

¹Carrier refers to the designation of the wood pulp from Table 1

### Example 4: Preparation of a Composition Using Solid-State Synthesis

Solid-state reactions are a common synthesis method to obtain polycrystalline material from solid reagents, without requiring a solution phase, such as water. Typically, very high temperatures are required for a solid-state reaction to complete.

A polymeric carrier, such as an organic fibre like lentil fibre (400 kg) containing about 40% (w/w) lignin and about 60% (w/w) cellulose, was mixed with 88 kg sodium carbonate. The mixture was tumbled in a rotary tumbling machine for one hour at a temperature of 30° C. Unlike a typical solid state reaction, 120 kg of ZnSO₄ was added to the mixture with 120 L of water. The mixture was tumbled for 30 minutes. The mixture was then heated to 70° C. and tumbled for 90 minutes, followed by cooling to 30° C. and tumbling for 60 minutes. The mixture was rinsed with water at a ratio of 10:1 water to mixture. The solid material was separated from the water and dried to 10% moisture content. In various other examples, ZnSO₄ may be substituted with one of FeSO₄, MnSO₄, ZnCl₂, FeCl₃ or MnCl₂. In various other examples, the lentil fibre may be substituted with one of pea fibre, rice hulls, wheat husk, starch, coconut husk, cattle manure, cannabis fibre, wood fibre, wheat straw, barley straw and a combination thereof.

As compared to Examples 1 and 2, the solid state synthesis process generated an amount of wastewater that was reduced by a factor of 60, resulting in large cost savings for commercial production. The total yield for the process was increased from about 50% for the solution method of Examples 1 and 2 to about 75% for the solid state synthesis process. The particle size of the obtained composition was also significantly reduced. In the liquid synthesis processes of Examples 1 and 2, small particles of the composition were left in suspension in the wastewater streams and could not be recovered. These small particles are highly desirable due to their high surface area. Using the solid state synthesis process, the particle size index improved from a range of 0.2 mm to 1 mm to a range of 0.05 mm to 1 mm for the solid state synthesis method. As measured using electron microscopy, 60% of particles were between 1.0 mm and 0.5 mm, 35% of particles were between 0.5 mm and 0.2 mm and 5% of particles were between 0.2 mm and 0.1 mm for the solid state method.

The same process was repeated using a manganese salt and an iron salt. All three compositions were tested for element loading using the same elemental analysis approach described in Example 3. The composition with zinc contained 19.5% (wt/wt) of zinc, based on a total weight of the composition. The composition with manganese contained 14.3% (wt/wt) of manganese, based on a total weight of the composition. The composition with iron contained 11.7% (wt/wt) of iron, based on a total weight of the composition.

### Example 5: Preparation of a Composition Using Microwave Assisted Organic Synthesis

Microwave assisted organic synthesis is based on the interaction of electromagnetic waves with polar molecules in a solution or mixture. Polar molecules in the presence of an oscillating electromagnetic field will re-orient in synchronization with the electromagnetic field. If the oscillating frequency of the electromagnetic field is high, such as in the microwave frequency range (2.5 Ghz), the rapid reorientation of the molecules will manifest a short reaction time period.

A carrier comprising an organic fibre (lentil fibre) (65 g) containing about 40% (w/w) lignin and about 60% (w/w) cellulose was mixed with 25 g of sodium carbonate. The mixture was mechanically mixed for 30 minutes at a temperature of 20° C. 30 g of ZnSO₄ was added to the mixture and the mixture was stirred for an additional 20 minutes at 20° C. The mixture was then irradiated with microwave energy at a frequency of 2.5 Ghz at a power level of 1700 Watts at an atmospheric pressure of 20 kPa until the temperature of the mixture was increased to 60° C. or 65° C. The microwave energy was stopped and the mixture was allowed to cool to 20° C. The mixture was rinsed with water at a ratio of 10:1 water to mixture. The composition was separated from the water and dried to 10% moisture content. The particles of the composition had a size of between 0.05 mm and 1 mm. As measured using electron microscopy, 40% of particles were between 1.0 mm and 0.5 mm, 20% of particles were between 0.5 mm and 0.2 mm, 10% of particles were between 0.2 mm and 0.1 mm and 30% of particles were between 0.1 mm and 0.05 mm for the microwave assisted method.

The same process was repeated using a manganese salt and an iron salt. All three compositions were tested for element loading using the same elemental analysis approach described in Example 3. The composition with zinc contained 19.2% (wt/wt) of zinc, based on a total weight of the composition. The composition with manganese contained 13.9% (wt/wt) of manganese, based on a total weight of the composition. The composition with iron contained 10.9% (wt/wt) of iron, based on a total weight of the composition.

In various other examples, ZnSO₄ may be substituted with one of FeSO₄, MnSO₄, ZnCl₂, FeCl₃ or MnCl₂. In various other examples, the lentil fibre may be substituted with one of pea fibre, rice hulls, wheat husk, lentil fibre starch, coconut husk, cattle manure, cannabis fibre, wood fibre, wheat straw, barley straw or a combination thereof.

As compared to Examples 1, 2 and 4, the reaction time using microwave assisted synthesis was reduced from 4-6 hours to approximately 1 minute. The total yield using this method was about 80% or greater. Overall, the cost of production was reduced by about 25% as compared to liquid synthesis and solid state synthesis. These costs are related to the high capital expenditures that are required for equipment capable of multi-hour residence time and energy costs associated with such expenditures.

### Example 6: Microbial Biomass in the Presence of Compositions Comprising Zinc

Compositions prepared according to Example 4 and incorporating zinc as the element were tested to determine the mode of action of the compositions disclosed herein. The compositions comprised 10% (wt/wt) zinc based on a total weight of the composition. A 60-day growth chamber experiment was carried out. Samples of soil were mixed with: (a) the composition, (b) zinc chloride, (c) zinc sulphate or (d) a control of pure soil. Each soil sample was incubated in 250 mL Mason jars. Headspace gas samples were collected using 50-mL polypropylene syringes and analyzed using gas chromatography.

Soil samples from the Mason jars were collected, homogenised and divided into two subsamples. One subsample was air-dried for zinc and other macro and micronutrient analyses, which the second subsample was stored at 4° C. in loosely tied plastic bags to ensure sufficient aeration and to prevent moisture loss before biological analysis.

The change in available zinc content was fitted using standard models available for soils (Shi, Z., Di Toro, D. M., Allen, H. E., Ponizovsky, A. A. 2005. Environ. Sci. Technol. 39: 4562-4568) and standard chelates to describe the zinc release kinetics of the composition compared to zinc chloride, zinc sulphate and the control of pure soil.

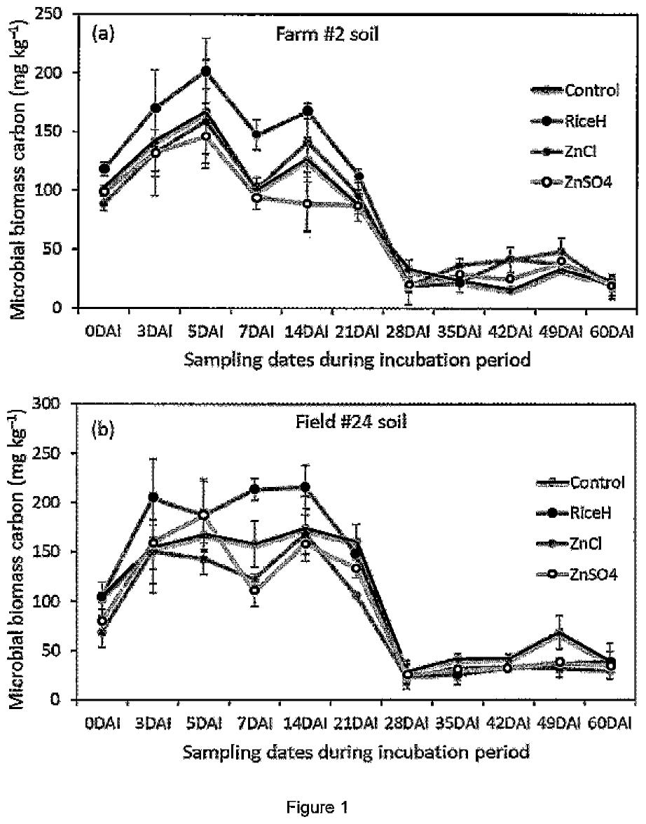

The evolution of microbial biomass carbon (MBC) in the soil marked as Farm #2 during the incubation period was characterized by three phases. During the first phase, day 0 to 5 days after incubation (“DAI”), MBC increased from 101 to 167 mg/kg under control, 118 to 202 mg/kg under the composition, 89 to 159 mg/kg under ZnCl, and 98 to 146 mg/kg under ZnSO₄ (FIG. 1(a)).

During the second phase, day 5 to 28 DAI, MBC decreased until 33.00 mg/kg under control, 19.10 mg/kg under the composition, 19.00 mg/kg under ZnCl and 19.80 mg/kg under ZnSO₄ (FIG. 1(a)).

During the third phase, day 28 to 60 DAI, MBC remained constant with average concentrations of 23.05 mg/kg under control, 31.22 mg/kg under the composition, 36.10 mg/kg under ZnCl, and 28.03 under ZnSO₄ (FIG. 1(a)).

The evolution of MBC in the soil marked Field #24 during the 60-day incubation period was also characterized by four phases. During the first phase, day 0 to 3 DAI, MBC increased from 102 mg/kg to 154 mg/kg under control, 104 mg/kg to 204 mg/kg under application of the composition, 68.72 mg/kg to 150 mg/kg with application of ZnCl, and 79 mg/kg to 159 mg/kg with application of ZnSO₄ (FIG. 1(b)).

During the second phase, day 3 to 21 DAI, MBC was on average 162 mg/kg under control, 193 mg/kg under the composition, 137 mg/kg under ZnCl, and 149 mg/kg under ZnSO₄ (FIG. 1(b)).

During the third phase, day 21 to 28 DAI, MBC decreased across all zinc sources.

During the fourth phase, day 28 to 60 DAI, the MBC remained constant with average values of 43.49 mg/kg under control, 31.18 mg/kg under the composition, 39.76 mg/kg under ZnCl and 31.74 mg/kg under ZnSO₄ (FIG. 1(b)).

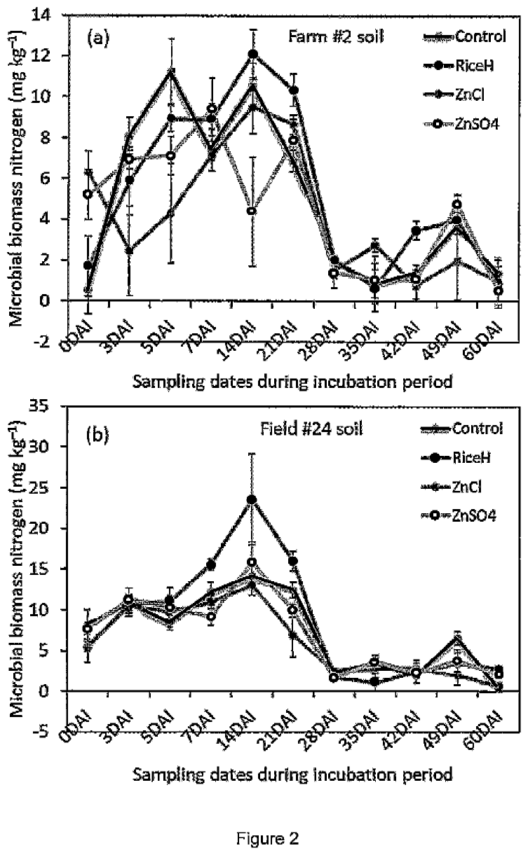

The evolution of microbial biomass nitrogen (MBN) in the soil labeled Farm #2 during the 60-day incubation period was characterized by three phases. During the first phase, day 0 to 21 DAI for the other zinc sources, the MBN increased from 0.59 mg/kg to 6.92 mg/kg under control, 1.72 mg/kg to 10.34 mg/kg with application of the composition, 6.31 mg/kg to 8.68 mg/kg under ZnCl, and 5.22 mg/kg to 7.90 mg/kg under ZnSO₄ (FIG. 2(a)).

During the second phase, day 21 to 28 DAI, the MBN decreased until 1.72 mg/kg across all zinc sources and remained constant up to 60 DAI across all zinc sources during the third phase (FIG. 2(a)).

The evolution of MBN in the soil sample labeled Field #24 during the 60-day incubation period was also characterized by three phases. During the first phase, day 0 to 14 DAI for the other zinc sources, the MBN increased from 8.16 mg/kg to 14.20 mg/kg under control, 5.42 mg/kg to 23.64 mg/kg with application of the composition, 5.52 mg/kg to 13.07 mg/kg under ZnCl, and 7.65 mg/kg to 15.79 mg/kg under ZnSO₄ (FIG. 2(b)).

During the second phase, day 14 to 28 DAI, the MBN decreased until 2.05 mg/kg across all zinc sources (FIG. 2(b)). During the third phase, day 28 to 60 DAI, there was some slight variations, but the average MBN was 2.52 mg/kg across all zinc sources (FIG. 2(b)).

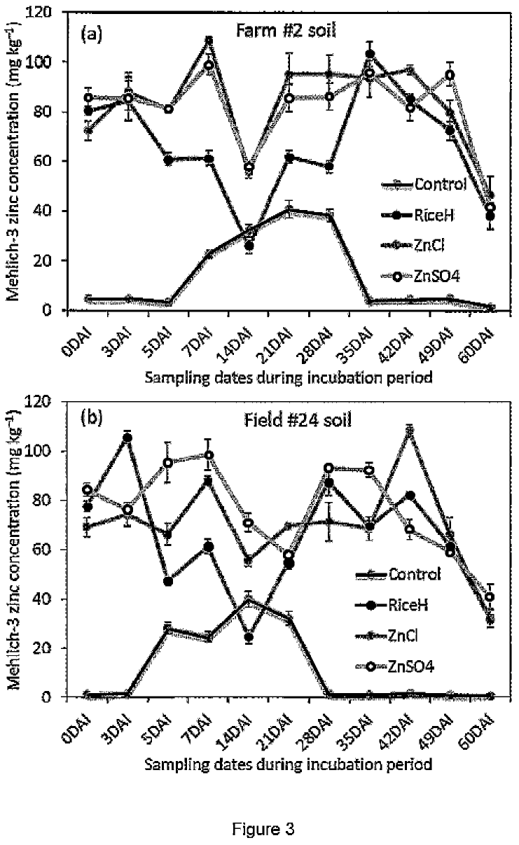

The evolution of Mehlich-3 extractable zinc in the two soil samples (Farm #2 and Field #24) were similar. Under control, there was an initial phase characterized as a constant trend of Mehlich-3 extractable zinc between 0 and 5 DAI for the soil of Farm #2, but 3 DAI for the soil of Field #24 (FIGS. 3(a) and 3(b)). After the constant phase, Mehlich-3 extractable zinc increased from 3.33 mg/kg to 38.46 mg/kg between 5 DAI and 28 DAI for Farm #2, and from 1.63 mg/kg to 32.12 mg/kg between 3 DAI and 21 DAI for Field #24 (FIGS. 3(a) and 3(b)).

Under application of the composition, there was an initial decreasing trend of Mehlich-3 extractable zinc from 80.45 mg/kg to 25.77 mg/kg in the soil of Farm #2, and from 77.60 mg/kg to 24.69 mg/kg in the soil of Field #24 between 0 DAI and 14 DAI (FIGS. 3(a) and 3(b)). The decreasing trend was followed by an increasing trend up to 35 DAI and then a decreasing trend until 60 DAI (FIGS. 3(a) and 3(b).

Under ZnCl and ZnSO₄ applications, there was some variability, but the general trend was a constant evolution from 0 DAI to 42 DAI with an average Mehlich-3 extractable zinc concentration of 85.96 mg/kg in the soils of Farm #2 and 78.16 mg/kg in the soil of Field #24 (FIGS. 3(a) and 3(b)).

Organic carbon is an important source of energy for micro-organisms in the soil. The results demonstrated that MBC associated with addition of the composition to soil increased during the first five days in the soil of Farm #2, and the first two weeks in the soil of Field #24 (FIGS. 1(a) and 1(b)). Throughout these two periods, the MBC associated with the composition was higher than that measured under control or the other chemical sources of zinc. This latter pattern was not clear for MBN, though there were slightly higher MBN concentrations under the composition compared with control and the other chemical sources of zinc curing the period between 7 and 21 DAI (FIGS. 2(a) and 2(b)).

The total organic carbon content of the composition used as a source of zinc for this study was 29.72%. In contrast, the decreasing trend of MBC and MBN beyond 21 DAI suggests a decreased amount of microorganisms present in the soil. This decreasing trend could be explained by a limited availability of mineral nitrogen in the soil necessary for microorganisms to feed on the carbon associated with the composition. The nitrogen content of the composition was 0.22% and the carbon to nitrogen ratio was 136, which indicate favourable conditions for nitrogen immobilization.

The decreasing pattern of Mehlich-3 extractable zinc concentrations during the first 14 DAI (FIGS. 3(a) and 3(b)), which is also in synchrony with the increasing MBC and MBN, indicates that microorganisms used the zinc associated with the composition while feeding on carbon (FIGS. 1(a), 1(b), 2(a) and 2(b)).

The zinc immobilized by microorganisms was released in the soil as shown by increasing trends of Mehlich-3 extractable zinc concentration between 14 DAI and 35 DAI, which is also in synchrony with increased MBC and MBN observed during the same period. Microorganisms therefore played an important role in the release of increased zinc concentrations associated with the composition.

In various embodiments, microbial biomass carbon may be elevated over 80% as compared to a control, the control being plants grown in the presence of conventional oxysulphate fertilizers.

### Example 7: Sorption/Desorption Characteristics for Zinc

The rate of sorption of zinc from the composition in cultivated soils is important in predicting the supply of zinc to plants. The rate of release of zinc from the composition was found to be greater than that of a standard chelate ZnCl used as sources of micronutrients in high value horticultural productions.

Air-dried and sieved (2-mm screen) soils collected in fields with contrasting properties were obtained (zinc concentrations low, medium or high; texture light or coarse; organic matter content low or high; and pH 4.8-5.8). Increasing concentrations (0, 100, 200, 300, 400, 500, 600, or 700 ppm) of zinc chloride, zinc sulphate and the composition were formulated in a 3 mM Ca(NO₃)₂ background electrolyte for batch equilibration with soils. The pH was maintained using 3 mM MES, which does not complex zinc ions.

Each sorption batch, replicated twice, consisted of 0.5 g air-dried and sieved soils added into a 40 mL centrifuge tube containing 25 mL of one of the equilibrating solutions. Each batch was shaken at 10 rpm end-over-end for a 40 hour contact time, centrifuged at 3000 g for 10 minutes, and then filtered through Whatman No. 42 filter paper. A 30 mL aliquot of the supernatant was removed to determine the amount of zinc in solution by ICP. These batch experiments were used to construct 7 to 8 point sorption curves. Two-site adsorption and desorption kinetics model were used to describe data of the batch experiments (Shi, Z., Di Toro, D. M., Allen, H. E., Ponizovsky, A. A. 2005. Environ. Sci. Technol. 39: 4562-4568).

The trend of zinc adsorption curves were different between the composition and ZnCl.

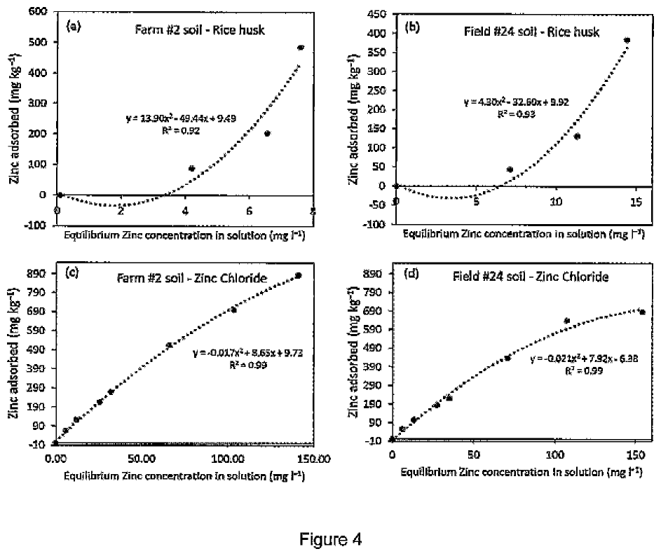

For the composition, the trend was described by a quadratic function with a positive slope of 13.90 in the soil of Farm #2 (FIG. 4(a)) and 4.30 in the soil of Field #24 (FIG. 4(b)). For ZnCl, the trend was also described by a quadratic function with a negative slope of −0.017 in the soil of Farm #2 (FIG. 4(c)) and −0.021 in the soil of Field #24 (FIG. 4(d)).

The equilibrium zinc concentration in the solution at the end of the sorption experiment varied between 0.09 and 7.89 mg/L in the soil of Farm #2 and between 0.05 and 14.66 mg/kg in the soil of Field #24 under the composition (FIGS. 4(a) and 4(b)). The equilibrium zinc concentration in the solution at the end of the sorption experiment varied between 0.08 and 140.95 mg/kg in the soil of Farm #2 and between 0.01 and 154.23 mg/kg in the soil of Field #24 under ZnCl (FIGS. 4(c) and 4(d)).

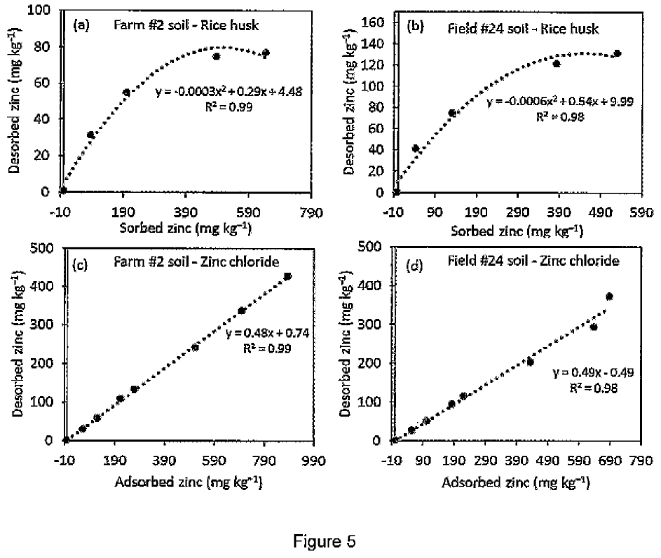

The trends of zinc desorption curves were different between the composition and ZnCl. For the composition, the trend was described by a quadratic function with a negative slope of −0.0003 in the soil of Farm #2 (FIG. 5(a)) and −0.0006 in the soil of Field #24 (FIG. 5(b)). For ZnCl, the trend was described by a linear function with a positive slope of 0.48 in the soil of Farm #2 (FIG. 5(c)) and 0.49 in the soil of Field #24 (FIG. 5(d)). The amount of desorbed zinc reached a plateau of about 80 mg/kg in the soil of Farm #2 and 140 mg/kg in the soil of Field #24 under the composition (FIGS. 5(a) and 5(b)). In contrast, within the range of zinc concentrations used for the sorption and desorption experiments, the amount of desorbed zinc increased linearly and the slope of the linear functions showed that for every unit of zinc adsorbed, 0.5 unit of zinc was desorbed under ZnCl (FIGS. 5(c) and 5(d)).

The composition as a source of zinc induced different sorption and desorption patterns compared with ZnCl. The adsorption curves indicate an increased sorption of zinc derived from the composition onto the soil as shown by the positive slopes of the quadratic functions. In contrast, the adsorption curves of ZnCl indicate that the sorption of zinc onto the soil solid phase is limited by an equilibrium between the solution and solid phase. The limited zinc concentration at equilibrium in the solution associated with the composition during the sorption and desorption experiments indicates that chemical processes alone do not control the release of zinc in the soil solution. These results point to the effects of microorganisms in the release of zinc from the composition.

### Example 8: Nutrient Uptake into Crop Tissues

Assessing application rates of the composition on high value horticultural crop growth and zinc uptake were assessed. The data demonstrated that nutrient or element uptake into crop tissues and crop growth were higher in the presence of the composition as compared with controls of standard zinc chelates.

A greenhouse experiment with peas (Pisum sativum) and cabbage (Lettuce sativa) was conducted at Agriculture and Agri-Food Canada's research facility in Agassiz, British Columbia, Canada. The experiment design was a split plot with three zinc sources as main plots (the composition, zinc chloride and zinc sulphate) and six zinc application rates as subplots (0, 50, 100, 150, 200 and 250 ppm) with three replicates for a total of 54 experimental units. A synthetic fertilizer containing nitrogen, phosphorus and potassium was used to supplement these macronutrients based on soil test. Pots used for the greenhouse experiments were 17 litre (30 cm diameter and 24 cm height) each with four holes at the bottom for drainage.

A hole was drilled at the bottom of each saucer to which a hose was glued to collect the leachate. Pots were filled first with 200 g of washed gravel to facilitate drainage and 1 kg of air-dried soil. All zinc treatments and soil were mixed thoroughly upon potting. Standard 5TE sensors were inserted in each pot and connected to an EM50 data logger to monitor daily volumetric water content, temperature and electrical conductivity. The plants were drip irrigated with two 1 L/hour drippers per bucket at a rate of one minute. Macronutrients were supplied through a drip irrigation system with two 1 L/hour drippers per bucket. Plant, soil and leachate samples collected during the two cycles were processed and analyzed for zinc and other macro and micronutrients. All data were analyzed statistically using Proc mixed of SAS Version 9.3 (SAS Institute, 2010, SAS User's Guide: Statistics, Version 9.3 ed. SAS Inst., Cary, NC).

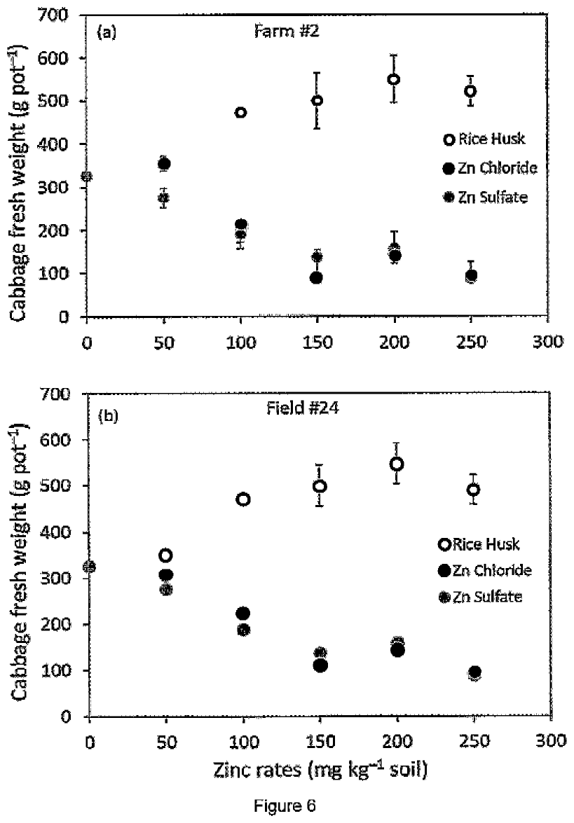

Cabbage fresh weight in the heavy textured soil (Farm #2) increased from 325 g/pot under control (no zinc) to a maximum of 550 g/pot (59%) with addition of 200 mg zinc/kg soil as the composition, 355 g/pot with addition of 50 mg zinc/kg soil as zinc chloride, but decreased steadily to 88 g/pot with addition of 250 mg zinc/kg soil as zinc sulphate (FIG. 6(a)).

Cabbage fresh weight in the light textured soil (Field #24) increased from 326 g/pot under control (no zinc) to a maximum of 546 g/pot with addition of 200 mg zinc/kg soil as the composition, but decreased steadily down to 93 g/pot and 88 g/pot with addition of 250 mg zinc/kg soil as zinc chloride and zinc sulphate, respectively (FIG. 6(b)).

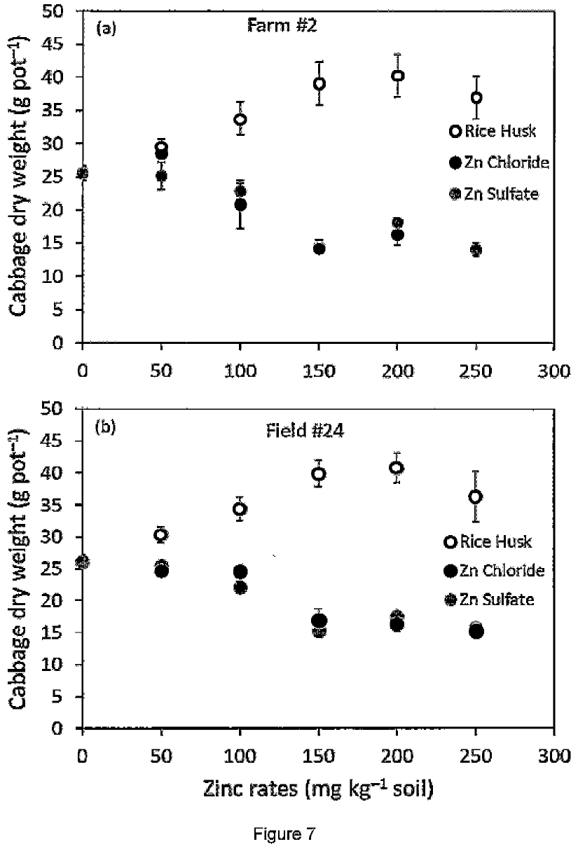

Cabbage dry weight in the heavy textured soil (Farm #2) increased from 25 g/pot under control (no zinc) to a maximum of 40 g/pot (62.5%) with addition of 150 mg zinc/kg soil as the composition, 29 g/pot with addition of 50 mg zinc/kg soil as zinc chloride, but decreased steadily to 14 g/pot with addition of 250 mg zinc/kg soil as zinc chloride and zinc sulphate, respectively (FIG. 7(a)).

Cabbage dry weight in the light textured soil (Field #24) increased from 26 g/pot under control (no zinc) to a maximum of 40 g/pot (65%) with addition of 150 mg zinc/kg soil as the composition, but decreased steadily to 15 g/pot with addition of 250 mg zinc/kg soil as zinc chloride and zinc sulphate, respectively (FIG. 7(b)).

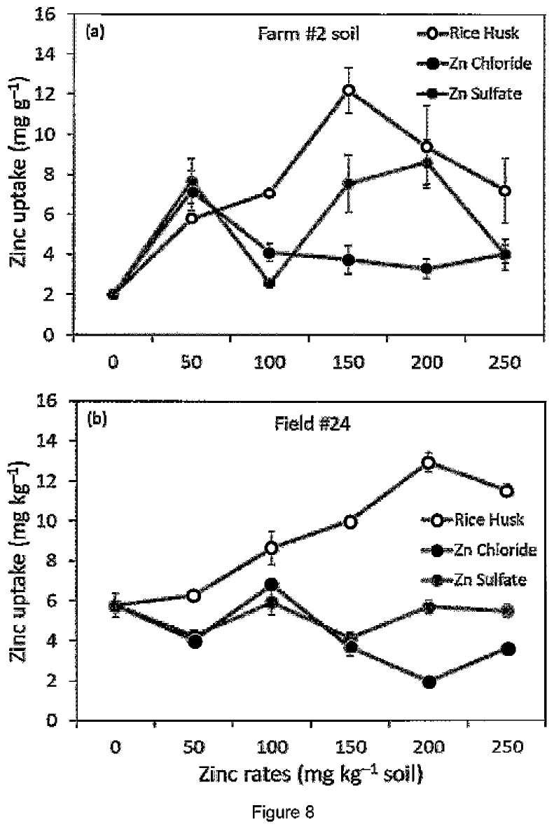

Zinc uptake in the heavy textured soil (Farm #2) increased from 1.9 mg/kg under control (no zinc) to a maximum of 4.2 mg/kg (45%) with addition of 200 mg zinc/kg soil as the composition, but decreased steadily to 1.1 mg/kg and 1.65 mg/kg with addition of 250 mg zinc/kg soil as zinc chloride and zinc sulphate, respectively (FIG. 8(a)).

Zinc uptake in the light textured soil (Field #24) increased from 5.8 mg/kg under control (no zinc) to a maximum of 12.9 mg/kg (45%) with addition of 200 mg zinc/kg soil as the composition, but decreased steadily to 1.9 mg/kg and 5.5 mg/kg with addition of 250 mg zinc/kg soil as zinc chloride and zinc sulphate, respectively (FIG. 8(b)).

The composition improved cabbage fresh yield, but a critical rate above which there is no significant increase in fresh yield was reached at 100 mg zinc/kg soil (FIGS. 6(a) and 6(b)). Cabbage fresh yield increase rates in the light textured soil (Farm #2) were 5%, 14% and 3% between 100 mg/kg soil and 150, 200 and 250 mg zinc/kg soil, respectively. Similarly, cabbage fresh yield increase rates in the heavy textured soil (Field #24) were 6%, 14% and 9% between 100 mg zinc/kg soil and 150, 200 and 250 mg zinc/kg soil, respectively. Cabbage fresh yield was not significantly different among the four rates (100, 150, 200, and 250 mg zinc/kg soil) in the two soils, suggesting a plateau response above 100 mg zinc/kg soil. In contrast, the addition of zinc as zinc chloride or zinc sulphate had a negative effect on cabbage yield even at rates as low as 50 mg zinc/kg soil.

Without wishing to be bound by theory, yield increase with addition of zinc as the compositions as disclosed herein may be explained by their lower solubility compared with the other elemental zinc products. This low solubility is well described by the adsorption isotherms of zinc derived from the composition (FIGS. 4(a) and 4(b)). The lower solubility of the composition is also well shown by the higher microbial carbon and nitrogen compared with the other element zinc products (FIGS. 1(a), 1(b), 2(a) and 2(b)). These higher microbial carbon and nitrogen obtained with the composition suggest that the release of zinc from the composition is partly controlled by microbial activity. It is possible that microorganisms feeding on the carbon associated with the composition free the zinc bonded to the composition, which is then taken up by plants. The decreasing trend of Mehlich-3 extractable zinc during the first 14 days of the incubation experiment coincided with the increase in microbial biomass carbon and nitrogen in the soils, suggesting that Mehlich-3 zinc beyond 14 DAI coincided with the decreases in microbial biomass carbon and nitrogen, suggesting a release of Mehlich-3 zinc by decaying microorganisms.

The rate of microbial activity is dependent on conditions such as temperature, moisture and pH. For example, warm and moist conditions facilitate a more active microbiome, whereas cool and dry conditions result in a less active microbiome. This means that elements from the composition are not released from the cellulose until environmental conditions promote microbial activity. Thus, the elements of the composition are available from plant uptake when favourable growing conditions are present.

Based on the foregoing, and without being bound by theory, it was found that when the compositions are applied to or incorporated into soil, the naturally present microbes begin to consume the organic carbon from the cellulose, increasing their microbial biomass carbon. In this process, the microbes also consume the cellulose-bound micronutrients, such as zinc, iron and manganese. Once the easily degraded carbon is consumed, the microbial population begins to decline, and the micronutrients are released back into the soli in a bioavailable form for plant uptake.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. The word “comprising” is used herein as an open-ended term, substantially equivalent to the phrase “including, but not limited to”, and the word “comprises” has a corresponding meaning. As used herein, the singular forms “a”, “an” and “the” include plural referents unless the context clearly dictates otherwise. Thus, for example, reference to “a thing” includes more than one such thing. Citation of references herein is not an admission that such references are prior art to the present invention. Any priority document(s) and all publications, including but not limited to patents and patent applications, cited in this specification are incorporated herein by reference as if each individual publication were specifically and individually indicated to be incorporated by reference herein and as though fully set forth herein. The invention includes all embodiments and variations substantially as hereinbefore described and with reference to the examples and drawings.

1. A composition comprising:
a polymeric carrier comprising cellulose and/or starch, wherein the carrier is insoluble in water; and
an element, wherein a salt of the element is soluble or partially soluble in water,
wherein the composition comprises at least about 5% (wt/wt) of the element, based on a total weight of the composition, and
wherein the composition has particle sizes between about 0.05 mm and about 1.5 mm.

2.-3. (canceled)

4. The composition of claim 1, wherein the element is Fe²⁺, Fe³⁺, Mn²⁺, Cu²⁺, Cu²⁺, Ca²⁺, Mo⁴⁺, Mo⁶⁺ or Zn²⁺.

5.-6. (canceled)

7. The composition of claim 1, wherein the carrier comprises about 0.2% to about 40% (w/w) lignin and about 60% to about 98.8% (w/w) cellulose to total weight of the carrier.

8. The composition of claim 1, wherein the particle sizes of the composition are between about 0.05 mm and about 0.2 mm.

9. The composition of claim 1, wherein the polymeric carrier is lentil fibre, pea fibre, rice hulls, wheat husk, starch, coconut husk, cattle manure, cannabis fibre, wood fibre, wheat straw, barley straw, oat fibre or a combination thereof.

10.-12. (canceled)

13. A solid state method for preparing a composition as defined in claim 1, the method comprising:
combining a base and a polymeric carrier comprising cellulose and/or starch in the absence or in the presence of water or a solvent;
adding a salt or an oxide of an element with water to form a mixture;
heating and mixing the mixture to form the composition;
separating the composition from the mixture; and
drying the composition to a moisture content of about 13% (wt/wt) or less.

14. The solid state method of claim 13, wherein the heating step is conducted between about 55° C. and about 80° C.

15. The solid state method of claim 13, wherein the base is anhydrous sodium carbonate, a sodium carbonate hydrate, potassium carbonate, anhydrous sodium hydroxide, a sodium hydroxide hydrate, anhydrous potassium hydroxide or a potassium hydroxide hydrate.

16. The solid state method of claim 13, wherein the base is sodium bicarbonate.

17. The solid state method of claim 13, wherein the salt is ZnSO₄, FeSO₄, MnSO₄, ZnCl₂, FeCl₃ or MnCl₂.

18. The solid state method of claim 13, wherein the carrier is lentil fibre, pea fibre, rice hulls, wheat husk, starch, coconut husk, cattle manure, cannabis fibre, wood fibre, wheat straw, barley straw, oat fibre or a combination thereof.

19. The solid state method of claim 13, wherein up to about 30% (w/w) base to total weight of the carrier is combined with the base.

20. The solid state method of claim 13, wherein the drying step comprises drying the composition to a moisture content of about 1% (wt/wt) to about 10% (wt/wt) based on a total weight of the composition.

21. A microwave assisted method for preparing a composition as defined in claim 1, the method comprising:
combining and mixing a base and a polymeric carrier comprising cellulose or a combination of cellulose and starch, in the absence or in the presence of water or a solvent;
adding a salt or an oxide of an element with water to form a mixture;
irradiating the mixture with microwave energy at atmospheric pressure or less to a temperature of about 40° C. to about 90° C.;
separating the composition from the mixture; and
drying the composition to a moisture content of about 13% (wt/wt) or less.

22. The microwave assisted method of claim 21, wherein the base is anhydrous sodium carbonate, a sodium carbonate hydrate, potassium carbonate, anhydrous sodium hydroxide, a sodium hydroxide hydrate, anhydrous potassium hydroxide or a potassium hydroxide hydrate.

23. The microwave assisted method of claim 21, wherein the base is sodium bicarbonate.

24. The microwave assisted method of claim 21, wherein the salt is ZnSO₄, FeSO₄, MnSO₄, ZnCl₂, FeCl₃ or MnCl₂.

25. The microwave assisted method of claim 21, wherein the carrier is lentil fibre, pea fibre, rice hulls, wheat husk, coconut husk, cattle manure, cannabis fibre, wood fibre, wheat straw, barley straw, oat fibre or a combination thereof.

26. The microwave assisted method of claim 21, wherein up to about 30% (w/w) base to total weight of the carrier is combined with the base.

27. The microwave assisted method of claim 21, wherein the drying step comprises drying the composition to a moisture content of about 1% (wt/wt) to about 10% (wt/wt) based on a total weight of the composition.
